(19) United States
(12) Patent Application Publication
(10) Pub. No.: US 2002/0017806 A1
(43) Pub. Date: Feb. 14, 2002

(54) Vehicle front-end panel made of thermoplastic resin

(76) Inventors: Satoru Funakoshi, Kameoka-shi (JP); Takeo Kitayama, Osaka (JP)

Correspondence Address: FITCH EVEN TABIN AND FLANNERY, 120 SOUTH LA SALLE STREET, SUITE 1600, CHICAGO, IL, 606033406

(21) Appl. No.: 09/778,853

(22) Filed: Feb. 8, 2001

(30) Foreign Application Priority Data
Feb. 14, 2000 (JP) 2000-034733
Feb. 14, 2000 (JP) 2000-034731

(51) Int. Cl. B60J 7/00

(52) U.S. Cl. 296/194

(57) ABSTRACT

The present invention provides a vehicle front-end panel made of a thermoplastic resin for constituting a vehicle front-end module, wherein the front-end panel comprises; (a) a thermoplastic resin; and (b-i) an electrically conductive material and/or (b-ii) an antistatic material, the vehicle front-end panel having electrical conductivity and/or an antistatic property.

### BACKGROUND OF THE INVENTION

1. Field of the Invention

The present invention relates to vehicle front-end panels made of thermoplastic resin, the front-end panel having electrical conductivity and/or an antistatic property.

2. Description of the Related Art

Vehicle front-end panels made of resin material are known conventionally and are disclosed in Japanese Patent Unexamined Publication Nos. 3-284481, 6-286657, etc. These front-end panels of resin are shown to have a structure in which a fan shroud, a radiator support and the like are combined. Moreover, Japanese Patent Unexamined Publication Nos. 10-264855 and 11-29069 disclose a front-end panel of resin combined with a metallic reinforcement.

The front-end panels made of resin disclosed in these publications are very light, but they are problematic in that dust is liable to attach due to electrification, causing the failure of vehicles or that electronic circuits for controlling vehicles break down due to static electricity generated and electromagnetic waves entered from the outside.

### SUMMARY OF THE INVENTION

Under these circumstances, the present inventors have diligently studied to develop a vehicle front-end panel made of thermoplastic resin, the front-end panel being light, difficult to be charged and resistant to the attachment of dust or the like thereto and having charge (static electricity) accumulation-preventing property and electromagnetic wave-intercepting property. As a result, they reached the present invention.

The present invention offers a vehicle front-end panel made of thermoplastic resin for constituting a vehicle front-end module, wherein the front-end panel comprises:

(a) a thermoplastic resin; and

(b-i) an electrically conductive material and/or (b-ii) an antistatic material.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step.

### BRIEF DESCRIPTION OF THE DRAWINGS

FIG. 1 illustrates an example of the front-end panel made of a thermoplastic resin of the present invention in its schematic view;

FIG. 2 illustrates an example of mold halves used in a method for producing the front-end panel made of a thermoplastic resin of the present invention in its schematic and cross-sectioned view;

FIG. 3 illustrates a production step in a method for producing the front-end panel made of a thermoplastic resin of the present invention and shows a state where a mold-cavity clearance is held at the thickness of a final article;

FIG. 4 illustrates a production step in a method for producing the front-end panel made of a thermoplastic resin of the present invention and shows a state where a molten resin has been filled into a mold-cavity;

FIG. 5 illustrates a production step in a method for producing the front-end panel made of a thermoplastic resin of the present invention and shows a state where after the filling of a molten resin into a mold-cavity and the solidification of the molten resin, both mold halves are opened and an article is taken out of the mold halves;

FIG. 6 illustrates a production step in a method for producing the front-end panel made of a thermoplastic resin of the present invention and shows a state where an electrically conductive thin-layered matter is supplied to between the mold-cavity surfaces so as to almost cover a mold-cavity surface;

FIG. 7 illustrates a production step in a method for producing the front-end panel made of a thermoplastic resin of the present invention and shows a state where a part of a thin-layered matter is sandwiched between a mold-body and a slide core;

FIG. 8 illustrates a production step in a method for producing the front-end panel made of a thermoplastic resin of the present invention and shows a state where a molten resin is fed with mold halves unclosed;

FIG. 9 illustrates a production step in a method for producing the front-end panel made of a thermoplastic resin of the present invention and shows a state where a molten resin is filled into a mold-cavity through mold-clamping to compress the molten resin and at the same time the thin-layered matter is impregnated with the molten resin;

FIG. 10 illustrates a production step in a method for producing the front-end panel made of a thermoplastic resin of the present invention and shows a state where both mold halves are opened after compression and cooling and an article is taken out of the mold halves;

FIG. 11 illustrates a production step in a method for producing the front-end panel made of a thermoplastic resin of the present invention and shows a state where an electrically conductive thin-layered matter is supplied to between the mold-cavity surfaces so as to almost cover a mold-cavity surface;

FIG. 12 illustrates a production step in a method for producing the front-end panel made of a thermoplastic resin of the present invention and shows a state where a molten resin is fed with mold halves unclosed;

FIG. 13 illustrates a production step in a method for producing the front-end panel made of a thermoplastic resin of the present invention and shows a state where a molten resin is filled into a mold-cavity and the molten resin and an electrically conductive thin-layered matter are integrally laminated;

FIG. 14 illustrates a production step in a method for producing the front-end panel made of a thermoplastic resin of the present invention and shows a state where both mold halves are opened after compression and cooling and an article is taken out of the mold halves;

FIG. 15 illustrates an example of the front-end panel made of a thermoplastic resin of the present invention in its schematic view;

FIG. 16 illustrates an example of mold halves used in a method for producing the front-end panel made of a thermoplastic resin of the present invention in its schematic and cross-sectioned view;

FIG. 17 illustrates a production step in a method for producing the front-end panel made of a thermoplastic resin of the present invention and shows a state where a mold-cavity clearance is held at the thickness of a final article;

FIG. 18 illustrates a production step in a method for producing the front-end panel made of a thermoplastic resin of the present invention and shows a state where a molten resin has been filled into a mold-cavity;

FIG. 19 illustrates a production step in a method for producing the front-end panel made of a thermoplastic resin of the present invention and shows a state where after the filling of a molten resin into a mold-cavity and the solidification of the molten resin, both mold halves are opened and an article is taken out of the mold halves;

FIG. 20 illustrates a production step in a method for producing the front-end panel made of a thermoplastic resin of the present invention and shows a state where a molten resin is fed with mold halves unclosed;

FIG. 21 illustrates a production step in a method for producing the front-end panel made of a thermoplastic resin of the present invention and shows a state where a molten resin is filled into a mold-cavity and the molten resin and an antistatic thin-layered matter are integrally laminated; and

FIG. 22 illustrates a production step in a method for producing the front-end panel made of a thermoplastic resin of the present invention and shows a state where both mold halves are opened after compression and cooling and an article is taken out of the mold halves.

### DETAILED DESCRIPTION OF THE INVENTION

The present invention is characterized in that in a vehicle front-end panel made of a thermoplastic resin for constituting a vehicle front-end module, the front-end panel comprises:

(a) a thermoplastic resin, and

(b-i) an electrically conductive material and/or (b-ii) an antistatic material.

As for the aforementioned vehicle front-end panel made of thermoplastic resin, it is preferable that the front-end panel has an internal resistivity of less than 1×10⁻¹ Ω·cm. Front-end panels having such internal resistivities can properly enjoy an antistatic effect and an electromagnetic wave-intercepting effect. It is preferable that the front-end panel has a surface resistivity of less than 1×10¹⁴ Ω·cm. Front-end panels having such surface resistivities can properly enjoy an antistatic effect. Furthermore, it is particularly preferable that the front-end panel has a surface resistivity of less than 1×10¹⁰ Ω·cm. Front-end panels having such surface resistivities can particularly properly enjoy a charge (static electricity) accumulation-preventing effect.

In the vehicle front-end panel made of thermoplastic resin, an electrically conductive material and/or an antistatic material may be contained in the thermoplastic resin and the electrically conductive material and/or the antistatic material may be present on the surface of the thermoplastic resin, provided that in the former case, when the thermoplastic resin contains only the antistatic material, it is important that the antistatic material is contained in the thermoplastic resin so that at least the surface portion of the front-end panel has the antistatic property.

The following explanation refers only to some examples of the present invention, but the invention is not limited to the examples.

### EXAMPLES

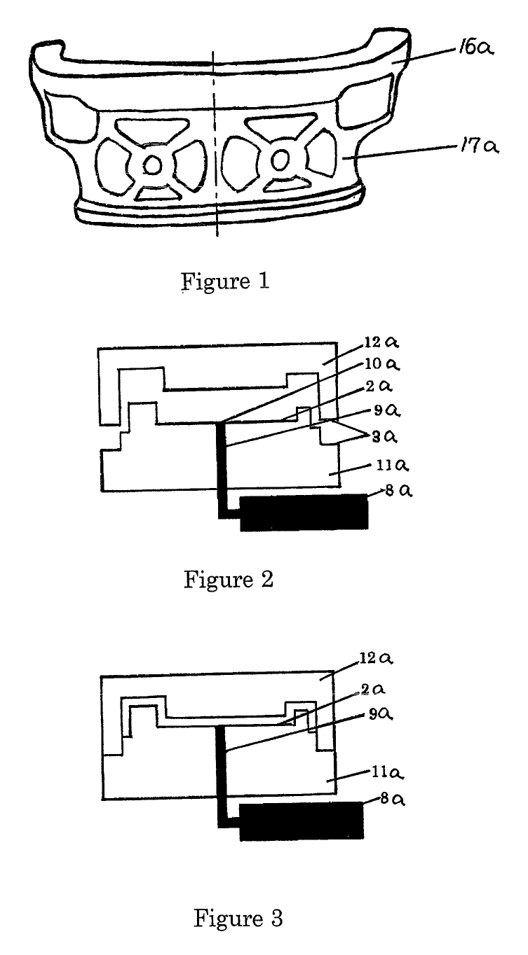

In one embodiment of the vehicle front-end panel made of thermoplastic resin of the present invention, the front-end panel has a form generally having an upper reinforcement (16a) positioned in the upper portion of the front-end panel and also having a radiator support (17a) in which a radiator is installed and a headlamp install portion below the upper portion of the front-end panel, as shown in FIG. 1. The front-end panel constitutes a front-end module together with a radiator, a radiator fan, a headlight and the like installed in those portions.

An electrically conductive front-end panel (15a), which is an embodiment of the present invention, is a front-end panel including a part connecting the front-end panel with a vehicle body. It does not include those having such a structure that a front-end panel has electrical conductivity only in its upper reinforcement mentioned above.

For the electrically conductive front-end panel of the present invention, the internal resistivity of the front-end panel is desirably less than 1×10⁻¹ Ω·cm, more desirably less than 1×10⁻² Ω·cm, and particularly desirably less than 1×10⁻³ Ω·cm for the purpose of achieving an antistatic effect and an electromagnetic wave-intercepting effect. In general, the smaller the internal resistivity, the more superior in electrical conductivity, namely charge (static electricity) accumulation property, the front-end panel is. If the front-end panel has an internal resistivity of less than 1×10⁻³ Ω·cm, it may show an electrical conductivity equivalent to that metallic materials have and it will become possible to charge the front-end panel itself with electricity.

The “internal resistivity” used in the present invention is a value calculated by making electric conductors such as metallic volts penetrate a front-end panel at two arbitrary points, measuring the value of resistivity between the electric conductors, and dividing the value of resistivity by the distance between the electric conductors. As for such an internal resistivity, the resistivity of the front-end panel in its thickness direction is leveled.

A method for producing the electrically conductive front-end panel of the present invention may be exemplified by a method in which a thermoplastic resin containing an electrically conductive material such as an electrically conductive filler kneaded therein is used as a molding material and the thermoplastic resin is molded into the shape of a front-end panel (a first method); a method in which an electrically conductive porous thin-layered matter such as a porous sheet-shaped or film-shaped matter is impregnated with a thermoplastic resin (a second method); or a method in which an electrically conductive surface layer is formed (a third method). The surface layer may, for example, be an electrically conductive thin-layered matter such as a sheet-shaped or film-shaped matter and coatings with electrically conductive materials including metal plating.

The first method makes a front-end panel have a structure in which almost the whole front-end panel has electrical conductivity because an electrically conductive material such as an electrically conductive filler is uniformly kneaded in the thermoplastic resin. The second method makes a front-end panel have a structure in which the front-end panel has electrical conductivity through an electrically conductive porous thin-layered matter such as a porous sheet-shaped or film-shaped matter. The third method makes a front-end panel have a structure in which the front-end panel has electrical conductivity through a surface part where an electrically conductive material has been applied or through a surface where an electrically conductive thin-layered matter such as a sheet-shaped or film-shaped matter is laminated, that is, through a surface layer.

The following is an explanation on a method for producing an electrically conductive front-end panel (15a).

First, explained is a method of molding by the use of a molten thermoplastic resin, which may henceforth be referred to simply as a “molten resin”, containing an electrically conductive filler kneaded therein.

FIG. 2 is a schematic view of mold halves used in such a method illustrated by a cross-section. The mold halves are composed of a pair of mold halves including a male mold half (11a) and a female mold half (12a). Usually, one of the mold halves is connected to a press machine and another is fixed and the mold half is thereby able to be opened and closed in a vertical or horizontal direction.

Although the molten resin may be supplied to a mold-cavity by any method, it is generally preferable that a resin supply opening that leads to a resin supply apparatus (8a) through a resin supply passage (9a) formed in a mold half is placed in any one or both of the molding surfaces of the male and female mold halves and the molten resin is supplied to the mold-cavity through the resin supply opening. In this case, the mold-assembly may have a structure in which a freely-controllable opening and closing valve is placed in the vicinity of the resin supply opening of the resin supply passage (9a) and the supplying condition of the molten resin accumulated in the resin supply apparatus of an injection machine or the like, including the start and halt of supplying the molten resin, can be freely controlled.

By the use of such mold halves, a thermoplastic resin (14a) containing the electrically conductive filler melt-kneaded is supplied with a resin supply apparatus (8a) such as a popular in-line type injection machine or the like.

As the thermoplastic resin to be used here, any thermoplastic resin which has been used for extrusion molding, injection molding or press molding may be used. Examples of general thermoplastic resins include polyethylene, polypropylene, polystyrene, acrylonitrile-styrene-butadiene copolymers, polyvinyl chloride, polycarbonate and polyethylene terephthalate, mixtures thereof, and polymer alloys using these thermoplastic resins.

Such a thermoplastic resin may, as needed, contain fillers such as reinforcing fiber and talc and also may optionally contain various kinds of additives such as pigments, lubricants and stabilizers.

The electrically conductive filler to be used in the present invention may be exemplified by long fibers, short fibers, powders or the like of metals such as iron, copper, brass, aluminum, stainless steel, nickel, tin and lead, carbon fibers, carbon powders, and electrically conductive fillers composed of electrically insulating inorganic fillers coated with metal. These electrically conductive fillers may be provided with various kinds of surface treatment for the improvement of adhesion to thermoplastic resin.

As the content of the electrically conductive filler increase, electrical conductivity is improved. The content of the filler may be properly determined depending upon a desired electrical conductivity. For example, in order to make the internal resistivity to be 1×10⁻¹ Ω·cm or less, about 1% by weight of electrically conductive filler is usually contained in a thermoplastic resin in the case, for example, of the use of stainless steel fiber. The upper limit of the filler content is not particularly limited, but it is about 50% by weight from the viewpoints of electrically conductive performance and cost.

The capacity and clearance of the mold-cavity defined by both mold halves at the time when a molten resin is filled into the mold-cavity are determined depending upon the volume of the molten resin (14a) to be fed, the final article thickness, etc.

A molten resin may be fed to between the mold halves that have formed a mold-cavity completely. It is also possible for the molten resin to be supplied in a state where no mold-cavity has been completely formed by both mold halves and the mold halves are unclosed. The start of supplying the molten resin is properly selected from the above options depending upon the shape of a desired front-end panel or the like. The mold-cavity clearance in the case of supplying the molten resin to between the unclosed mold halves is usually not greater than about (the thickness of a final article+100 mm).

The temperature of the molten resin (14a) to be supplied varies depending upon the type of the thermoplastic resin to be used, molding conditions or the type of the electrically conductive filler to be used and is properly set to the optimum temperature.

For example, in the case of using a thermoplastic resin comprising a polypropylene-based resin as a matrix and stainless steel fibers as an electrically conductive filler, the temperature of the molten resin to be supplied is from about 170° C. to about 300° C., preferably from about 200° C. to about 280° C.

The filling of a molten resin (14a) into a mold-cavity may be conducted either by a method of filling by injection or by a method using an action of clamping both mold halves. The manner of filling the molten resin into the mold-cavity may be properly selected from the above options depending upon the form of a desired article.

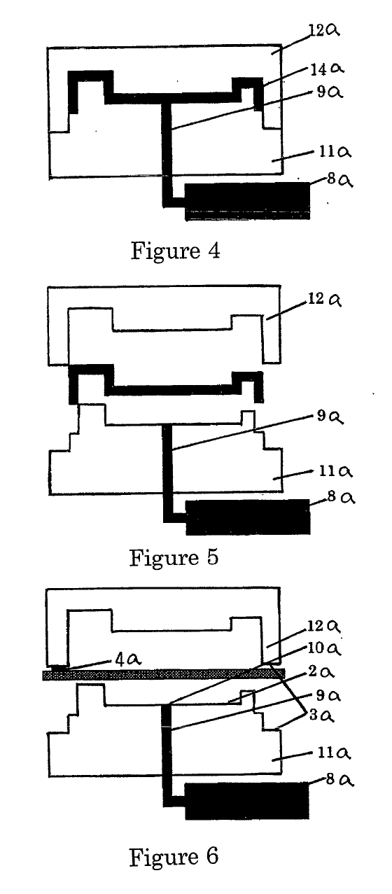

For example, it is possible for a molten resin to be filled into a mold-cavity (FIG. 4) while the mold-cavity clearance is kept at the thickness of a final article (FIG. 3). In this event, the mold-cavity clearance may momentarily become greater than the thickness of a final article in the course of supplying the molten resin. This, however, does not constitute any matter in this method.

In the case where a molten resin is filled through the action of clamping both mold halves, it is possible to commence the supply of the molten resin to between the mold halves which are in an unclosed state where the mold-cavity clearance is greater than the thickness of a final article and fill the molten resin into the mold-cavity by conducting the mold-clamping at the same time of or after the completion of supplying the molten resin. Alternatively, the mold-clamping may be commenced during the supply of the molten resin.

In any of the above methods, both mold halves are opened after filling the molten resin into the mold-cavity and solidifying the molten resin and then an article is taken out of the mold halves (FIG. 5).

In such production methods, vehicle front-end panels having electrical conductivity made of thermoplastic resin can be readily produced.

The electrically conductive front-end panel of the present invention can also be prepared by another method in which a porous thin-layered matter (1a) is impregnated with a thermoplastic resin. As mold halves, that comprising a pair of mold halves like that described above may be used.

In the case of using this method, a porous thin-layered matter (1a) is supplied to between both mold-cavity surfaces so as to almost cover at least one of the mold-cavity surfaces (FIG. 6).

The porous thin-layered matter (1a) to be used here may be exemplified by knits, woven fabrics, meshes or non-woven fabrics made of metallic fibers or electrically conductive fibrous materials prepared by coating carbon fibers or inorganic fibers with metal. As a fibrous material for the porous thin-layered matter has greater adhesion to a thermoplastic resin (14a), which is a matrix, it shows a higher reinforcing effect. The fibrous material therefore may be provided with some surface treatment for the improvement of its adhesion.

As for the porous thin-layered matter (1a), either a single thin-layered matter may be used or plural thin-layered matters may be supplied with being piled together. The porous thin-layered matter may be placed so that it covers one or both surfaces of the article or it is present uniformly in the thickness direction of the article. Alternatively, a great amount of porous thin-layered matter may be supplied so that it is piled thickly in a region where a specifically high electrical conductivity is required to be achieved.

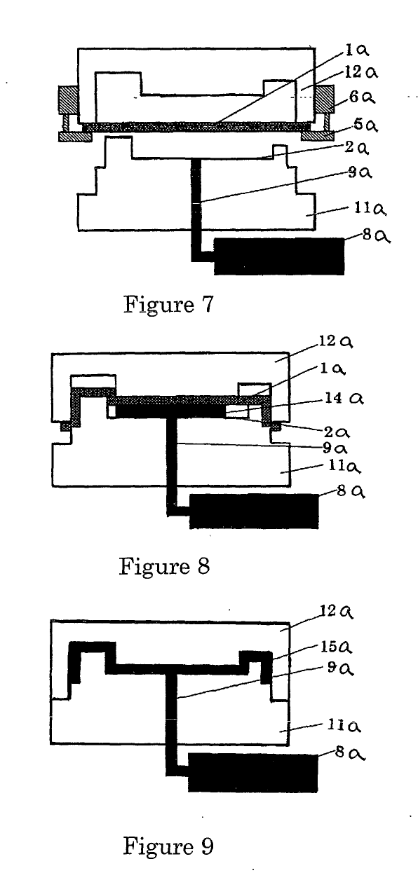

In the supply of the porous thin-layered matter, it may be fixed to a mold-cavity surface (2a) or periphery thereof (3a) for the purpose of preventing the porous thin-layered matter from slipping from mold halves surface or wrinkling. In such a case, the porous sheet-shaped matter may be fixed by using an adhesive material (4a), such as a double-faced tape, located on the mold-cavity surface or its periphery or, alternatively, may be fixed by a simple technique such as use of a Velcro fastener. Moreover, it is also possible to install a clamp structure (5a) for clipping a porous thin-layered matter to the mold-cavity surface or its periphery as illustrated in FIG. 7. The clamp structure may be one in which a part of a mold half is composed of a slide core and a part of the porous thin-layered matter is sandwiched between a body of the mold half and the slide core by the use of a known technique such as a spring or a hydraulic or air cylinder (6a). The mold half to which the porous thin-layered matter is fixed may be one or both mold halves. The fixing manner may be selected properly depending upon the shape of a desired article or the type of the porous thin-layered matter to be used.

In the case of the use of a mold half having a resin supply opening (10a) in its mold-cavity surface (2a) shown in figures, it is preferable that the porous thin-layered matter (1a) is supplied so that it covers the resin supply opening. In this event, a hole larger than the resin supply opening may be opened in the porous thin-layered matter in its portion right above the resin supply opening.

Next, a molten thermoplastic resin (14a) is supplied into the mold halves. The thermoplastic resin to be used here may be those described above, which may further contain electrically conductive fillers, as needed.

The supply of the molten resin and its supply into a mold-cavity are conducted in the same manner as described above.

In the case where the molten resin (14a) is supplied to between mold halves that have been formed a mold-cavity completely, the mold-cavity capacity of the mold-cavity at the commencement of supplying the thermoplastic resin is controlled through properly setting the mold-cavity clearance in the thickness direction of an article. If the mold-cavity clearance is too narrow, the porous thin-layered matter (1a) breaks or slips. Therefore, the mold-cavity clearance is usually about 5 to 100% of the thickness of a final article.

On the other hand, in the case where both mold halves have formed no mold-cavity and the mold-cavity clearance defined at the commencement of supplying the molten resin is greater than the thickness of a final article and the molten resin (14a) is supplied in a state where the mold half is unclosed (FIG. 8), the mold-cavity clearance is selected properly depending, for example, upon conditions of the porous thin-layered matter (1a) and molten resin to be used. By the use of this technique, the porous thin-layered matter becomes more difficult to break or wrinkle in comparison with the former case. The mold-cavity clearance in this case is not greater than about (the thickness of a final article+100 mm).

The filling of a molten resin (14a) into a mold-cavity may be conducted either by a method of filling by injection or by a method using an action of clamping both mold halves. The manner of filling the molten resin into the mold-cavity is properly selected from the above options depending upon the form of a desired article.

For example, it is possible for a molten resin (14a) to be filled into a mold-cavity while the mold-cavity clearance is kept at the thickness of a final article. At this time, the molten resin is desirably filled so that a pressure of about 1 to 50 MPa is applied to the molten resin.

In this case, although the mold-cavity clearance may momentarily become greater than the thickness of a final article in the course of supplying the molten resin. This, however, does not constitute any matter in this method.

The porous thin-layered matter is impregnated with the molten resin (14a) by its supply pressure.

In another embodiment, in the case where supplying the molten resin (14a) to between the mold halves is commenced when the mold halves are in an unclosed state, the molten resin may be filled into the mold-cavity at the same time supplying the molten resin is finished. Alternatively, the mold-clamping may be commenced during the supply of the molten resin.

In this case, by compressing the molten resin through mold-clamping, the molten resin is filled into the mold-cavity and at the same time the thin-layered matter (1a) is impregnated with the molten resin (FIG. 9).

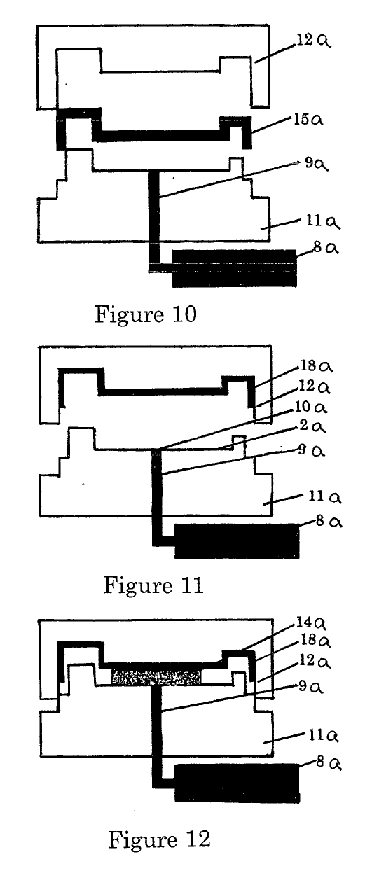

After cooling under pressure in this state, both mold halves are opened and a front-end panel (15a) as an article is taken out of the mold halves (FIG. 10).

After taking out the article, an open portion of the front-end panel and extruded edge part of the porous thin-layered matter may be cut away. Moreover, the porous thin-layered matter may be cut in advance into the shape of a desired front-end panel in conformity with its outside shape and its open portion.

The following is an explanation on a method for producing a front-end panel comprising a thermoplastic resin and an electrically conductive thin-layered matter such as a sheet-shaped or film-shape matter (18a) which is integrally laminated to the thermoplastic resin.

In this technique, mold halves comprising a pair of mold halves like that previously described may be also employed.

The thin-layered matter such as a sheet-shaped or film-shaped matter (18a) is first supplied to between both mold-cavity surfaces so as to almost cover at least one of the mold-cavity surfaces (FIG. 11). At this time, depending upon the properties of the thin-layered matter such as a sheet-shaped or film-shaped matter, it may be supplied along a mold-cavity surface as shown in FIG. 11 or may be supplied to between the mold-cavity surfaces while maintaining a planar state or may be shaped in advance into a predetermined shape.

The thin-layered matter such as a sheet-shaped or film-shaped matter to be used here may be thin-layered matters such as sheet-shaped or film-shaped matters made of insulating material, such as resin material, having a coating of carbon, metallic material or the like thereon, thin-layered matters such as sheet-shaped or film-shaped matters made of insulating material with a metallic film laminated thereon, thin-layered matters such as sheet-shaped or film-shaped matters made of insulating material coated with an electrically conductive paint or the like, or thin-layered matters such as sheet-shaped or film-shaped matters made of resin material having electrically conductive fibers or powders mixed therein.

The electrically conductive thin-layered matter such as a sheet-shaped or film-shaped matter may be provided with surface treatment such as the application of adhesive for the improvement of adhesion to thermoplastic resins that are to become a substrate of a front-end panel.

Such a thin-layered matter (18a) may be laminated to either one or both surfaces of an article. In the case of laminating to both surfaces, a molten resin may be supplied, for example, in such a manner that, in the state shown in FIG. 11, another thin-layered matter is further placed on the mold-cavity surface of the male mold half (11a), an opening is provided in the area of this thin-layered matter corresponding to the resin supply opening (10a) and the molten resin is supplied to between the upper and lower thin-layered matters through the resin supply opening.

In the supply of the electrically conductive thin-layered matter, it may be fixed to a mold-cavity surface (2a) or periphery thereof (3a) for the purpose of preventing the thin-layered matter from slipping from a mold halves surface or wrinkling. In such a case, the thin-layered matter may be fixed by using an adhesive material, such as a double-faced adhesive tape, located on the mold-cavity surface or its periphery or, alternatively, may be fixed by a simple techniques such as use of a Velcro fastener as in the case described previously. Moreover, it is also possible to install a clamp structure (5a) for clipping a thin-layered matter to the mold-cavity surface or its periphery.

The filling of a molten resin (14a) into a mold-cavity may be conducted either by a method of filling by injection or by a method using an action of clamping both mold halves like the methods described above. The manner of filling the molten resin into the mold-cavity is properly selected from the above options depending upon the form of a desired article. The description on a mold-cavity clearance provided earlier may also be applied to each of the above filling methods.

For example, a molten resin may be filled in such a manner that after the supply of an electrically conductive thin-layered matter to between a female and male mold halves, the mold half is closed so that the mold-cavity clearance becomes the thickness of a final article and then a molten resin is filled into the closed mold-cavity by injection. Alternatively, a molten resin may be filled in such a manner that after the supply of an electrically conductive thin-layered matter to between a female and male mold halves (FIG. 11), a molten resin (14a) is supplied to between the unclosed mold halves (FIG. 12) and is filled by mold-clamping. In the latter case, the molten resin may be filled into the mold-cavity at the same time when the supply of the molten resin is finished. Alternatively, the mold-clamping may be commenced during the supply of the molten resin.

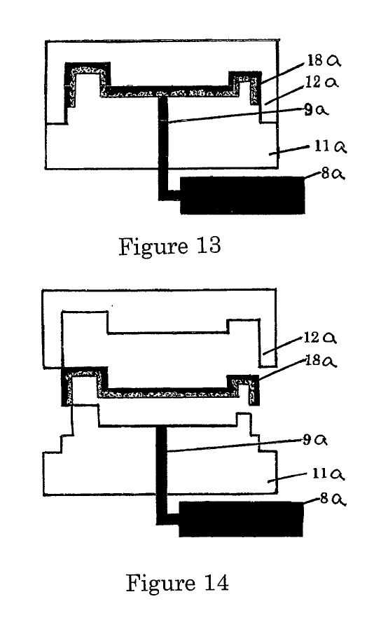

The molten resin (14a) is filled into the mold-cavity in such ways, being laminated integrally with the electrically conductive thin-layered matter (18a) (FIG. 13). After cooling under pressure while maintaining this state, both mold halves are opened and an article is taken out of the mold halves (FIG. 14).

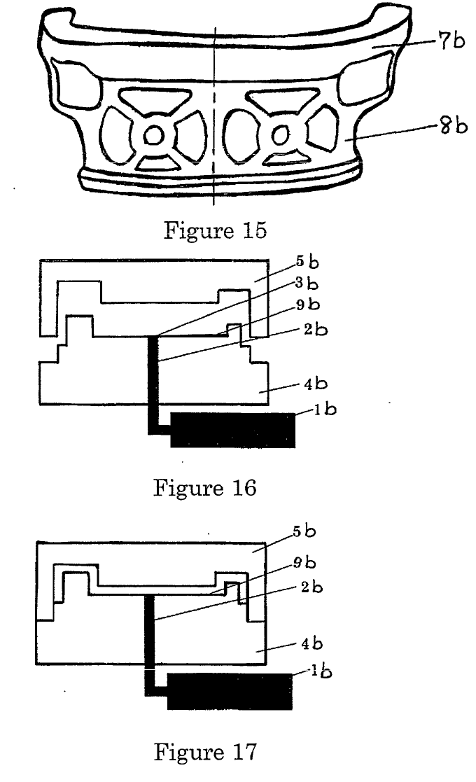

In one embodiment of the vehicle front-end panel made of a thermoplastic resin of the present invention, the front-end panel has a form generally having an upper reinforcement (7b) positioned in the upper portion of the front-end panel and also having a radiator support (8b) in which a radiator is installed and a headlamp install portion below the upper portion of the front-end panel, as shown in FIG. 15. The front-end panel constitutes a front-end module together with a radiator, a radiator fan, a headlight and the like installed in those portions.

An antistatic front-end panel (6b), which is an embodiment of the present invention, is a front-end panel including a part connecting the front-end panel with a vehicle body. It does not include those having such a structure that a front-end panel has antistatic properties only in its upper reinforcement mentioned above. Moreover, it is important that at least a surface portion of the front-end panel has antistatic properties and the front-end panel of the present invention does not include those having such a structure that only the center portion of the front-end panel in its thickness direction has the antistatic properties.

For the antistatic front-end panel made of thermoplastic resin of the present invention, the surface resistivity of the front-end panel is desirably less than 1×10¹⁴ Ω·cm, more desirably less than 1×10¹² Ω·cm, and particularly desirably less than 1×10¹⁰ Ω·cm. In general, the smaller the surface resistivity, the more superior in antistatic properties the front-end panel is. Surface resistivities of less than 1×10¹⁰ Ω·cm permit the prevention of the accumulation of charges in front-end panels almost to perfection.

The “surface resistivity” used in the present invention is a value measured under conditions: the humidity is 50% and the temperature is 23° C. The surface resistivity may be measured by various kinds of conventionally known methods for measuring a surface resistivity. Examples of such measuring methods include the voltage/current method, the bridge method, the charging method and a method of comparing with a standard resistance.

A method for producing the antistatic front-end panel of the present invention may be exemplified by a method in which a thermoplastic resin containing an antistatic material kneaded therein is used as a molding material and the thermoplastic resin is molded into the shape of a front-end panel (a first method); a method in which an antistatic material is applied to one or both surfaces of a thermoplastic resin front-end panel formed in advance (a second method); or a method in which an antistatic thin-layered matter such as a sheet-shaped or film-shaped matter (10b) is adhered (a third method).

The antistatic material used in the present invention is not particularly restricted, and various kinds of conventionally known antistatic agents and antistatic thin-layered matters and the like are applicable as an antistatic material. Examples of the antistatic agent include surfactants such as cationic surfactants, anionic surfactants, nonionic surfactants and amphoteric surfactants and quaternary ammonium salts.

The content of such antistatic agents varies depending upon the type of antistatic agents and the desired antistatic properties. However, in the case where an antistatic agent is used by being kneaded into a thermoplastic resin, its content is, in general, from about 0.05% by weight to about 10% by weight relative to the thermoplastic resin.

In the front-end panel produced by the first method, an antistatic material such as an antistatic agent uniformly kneaded in a thermoplastic resin bleeds out to the surface of the thermoplastic resin to form an antistatic layer thereon. The front-end panel produced by the first method has a structure where almost the whole surface of the front-end panel has antistatic properties. The front-end panel produced by the second or third method has a structure in which the front-end panel has antistatic properties through a surface part where an antistatic material has been applied or through a surface where an antistatic thin-layered matter such as a sheet-shaped or film-shaped matter is laminated, that is, through a surface layer.

The following is an explanation on a method for producing an antistatic front-end panel.

First, explained is a method of molding by the use of a molten thermoplastic resin, which may henceforth be referred to simply as a “molten resin”, containing an antistatic material such as an antistatic agent kneaded therein.

FIG. 16 is a schematic view of mold halves used in such a method illustrated by a cross-section. The mold halves are composed of a pair of mold halves including a male mold half (4b) and a female mold half (5b). Usually, one of the mold halves is connected to a press machine and another is fixed and the mold half is thereby able to be opened and closed in a vertical or horizontal direction.

Although the molten resin may be supplied to a mold-cavity by any method, it is generally preferable that a resin supply opening (3b) that leads to a resin supply apparatus (1b) through a resin supply passage (2b) formed in a mold half is placed in any one or both of the molding surfaces (9b) of the male and female mold halves and the molten resin is supplied to the mold-cavity through the resin supply opening. In this case, the mold-assembly may have a structure in which a freely-controllable opening and closing valve is placed in the vicinity of the resin supply opening of the resin supply passage (2b) and the supplying condition of the molten resin accumulated in the resin supply apparatus of an injection machine or the like, including the start and halt of supplying the molten resin, can be freely controlled.

By the use of such mold halves, a thermoplastic resin (6b) containing the antistatic material such as an antistatic agent melt-kneaded is supplied with a resin supply apparatus (1b) such as a popular in-line type injection machine or the like.

As the thermoplastic resin to be used here, any thermoplastic resin which has been used for extrusion molding, injection molding or press molding may be used. Examples of general thermoplastic resins include polyethylene, polypropylene, polystyrene, acrylonitrile-styrene-butadiene copolymers, polyvinyl chloride, polycarbonate and polyethylene terephthalate, mixtures thereof, and polymer alloys using these thermoplastic resins.

Such a thermoplastic resin may, as needed, contain fillers such as reinforcing fiber and talc and also may optionally contain various kinds of additives such as pigments, lubricants and stabilizers.

The capacity and clearance of the mold-cavity defined by both mold halves at the time when a molten resin is filled into the mold-cavity are determined depending upon the volume of the molten resin (6b) to be fed, the final article thickness, etc.

A molten resin may be fed to between the mold halves that have formed a mold-cavity completely. It is also possible for the molten resin to be supplied in a state where no mold-cavity has been completely formed by both mold halves and the mold halves are unclosed. The start of supplying the molten resin is properly selected from the above options depending upon the shape of a desired front-end panel or the like. The mold-cavity clearance in the case of supplying the molten resin to between the unclosed mold halves is usually not greater than about (the thickness of a final article+100 mm).

The temperature of the molten resin (6b) to be supplied varies depending upon the type of the thermoplastic resin to be used, molding conditions or the type of the antistatic material such as an antistatic agent to be used and is properly set to the optimum temperature.

For example, in the case of using polypropylene-based resins as the thermoplastic resin and metal salts of imidazoline-type amphoteric surfactants as the antistatic material, the temperature of the molten resin to be supplied is from about 170° C. to about 300° C., preferably from about 200° C. to about 280° C.

The filling of a molten resin (6b) into a mold-cavity may be conducted either by a method of filling by injection or by a method using an action of clamping both mold halves. The manner of filling the molten resin into the mold-cavity may be properly selected from the above options depending upon the form of a desired article.

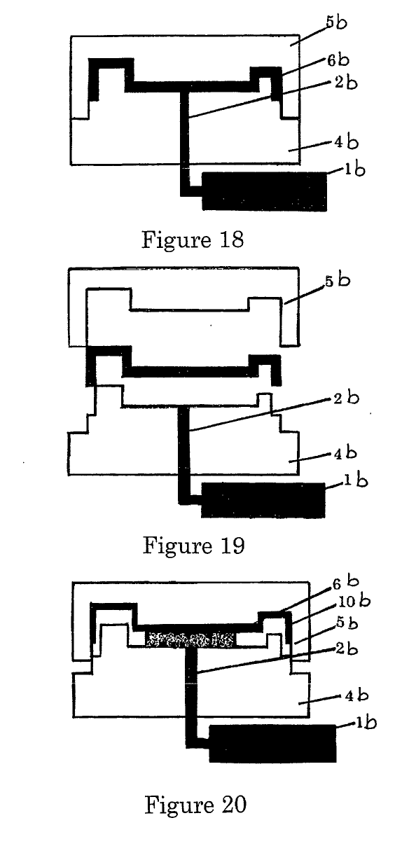

For example, it is possible for a molten resin to be filled into a mold-cavity (FIG. 18) while the mold-cavity clearance is kept at the thickness of a final article (FIG. 17). In this event, the mold-cavity clearance may momentarily become greater than the thickness of a final article in the course of supplying the molten resin. This, however, does not constitute any matter in this method.

In the case where a molten resin is filled through the action of clamping both mold halves, it is possible to commence the supply of the molten resin to between the mold halves which are in an unclosed state where the mold-cavity clearance is greater than the thickness of a final article and fill the molten resin into the mold-cavity by conducting the mold-clamping at the same time of or after the completion of supplying the molten resin. Alternatively, the mold-clamping may be commenced during the supply of the molten resin.

In any of the above methods, both mold halves are opened after filling the molten resin into the mold-cavity and solidifying the molten resin and then an article is taken out of the mold halves (FIG. 19).

In such production methods, vehicle front-end panels having antistatic property made of thermoplastic resin can be readily produced.

In the front-end panel produced by the second method, the front-end panel is produced by applying a predetermined amount of antistatic material to a desired surface of a thermoplastic resin front-end panel pre-formed. In this case, the front-end panel may be produced by pre-forming a front-end panel made of a thermoplastic resin in the same manner as describe earlier except using a thermoplastic resin with no antistatic material kneaded therein and applying an antistatic material to the entire or a desired part of any one or both surfaces of the front-end panel in conventional application methods using a brush, a spray gun or the like. In the application, the antistatic material may optionally be diluted to a desired concentration with organic solvents, water or the like depending upon the type of the antistatic material. The application amount may be set properly to a value sufficient to obtain desired antistatic properties.

In the front-end panel produced by the third method, the antistatic thin-layered matter such as a sheet-shaped or film-shaped matter may be laminated integrally to a desired surface of a thermoplastic resin front-end panel pre-formed with adhesive or screws. However, a practically advantageous method is one in which a thermoplastic resin front-end panel is formed and at the same time an antistatic thin-layered matter such as a sheet-shaped or film-shaped matter is adhered thereto to integrally laminate.

As the antistatic thin-layered matter such as a sheet-shaped or film-shaped matter to be used in these methods, a thin-layered matter such as a sheet-shaped or film-shaped matter is generally used which is prepared by forming a thermoplastic resin containing a predetermined amount of antistatic material kneaded therein as mentioned in the description on the first method, into a thin-layered matter such as a sheet or film shape by a conventional method.

Moreover, such a thin-layered matter such as a thin-layered matter such as a sheet-shaped or film-shaped matter may be provided with surface treatment such as the application of adhesive for the improvement of adhesion to thermoplastic resins that are to become a substrate of a front-end panel.

In the case where a thermoplastic resin front-end panel is formed and at the same time an antistatic thin-layered matter such as a sheet-shaped or film-shaped matter is adhered thereto to integrally laminate, the article may be produced of the aforementioned first method.

An antistatic thin-layered matter (10b) is first supplied to between a pair of unclosed female and male mold halves. At this time, the antistatic thin-layered matter such as a sheet-shaped or film-shaped matter may optionally be pre-formed into a predetermined shape. If it is desired to partly laminate the antistatic thin-layered matter, the thin-layered matter may be supplied locally to the predetermined position of a mold-cavity surface.

In the supply of the antistatic conductive thin-layered matter, it may be fixed to a mold-cavity surface (2b) or periphery thereof (3b) for the purpose of preventing the thin-layered matter from slipping from a mold halves surface or wrinkling. In such a case, the thin-layered matter may be fixed by using an adhesive material, such as a double-faced adhesive tape, located on the mold-cavity surface or its periphery or, alternatively, may be fixed by a simple techniques such as use of a Velcro fastener as in the case described previously. Moreover, it is also possible to install a clamp structure for clipping a thin-layered matter to the mold-cavity surface or its periphery.

Next, a molten thermoplastic resin (6b) containing no antistatic material is supplied into mold halves.

The supply of the molten resin and the supply into a mold-cavity are conducted in the same manner as previously described. By making the mold-cavity clearance defined at the commencement of the supply of the molten resin greater than the thickness of a final article and supplying the molten resin in a state where the mold halves are unclosed (FIG. 20), the thin-layered matter can be prevented from breaking or wrinkling.

The mold-cavity clearance in this case may be selected properly depending, for example, upon conditions of the thin-layered matter to be used and the molten resin to be supplied. The mold-cavity clearance is usually not greater than about (the thickness of a final article+100 mm).

In the case where the molten resin is supplied to between the unclosed mold halves, the filling of the molten resin into the mold-cavity is conducted by the action of clamping both mold halves. The mold-clamping may be conducted after or at the same time when the supply of the molten resin is finished. Alternatively, the mold-clamping may be commenced during supplying the molten resin.

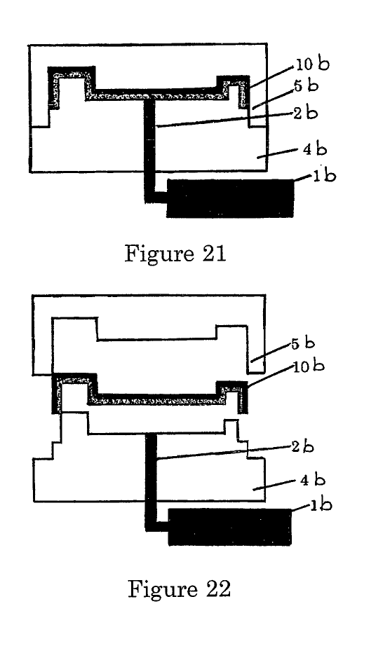

By compressing the molten resin through mold-clamping, the molten resin is filled into the mold-cavity. An antistatic thin-layered matter is integrally laminated to a surface of a front-end panel made of thermoplastic resin through compressing the molten resin while keeping the mold-cavity clearance at the thickness of a final article (FIG. 21).

After cooling under pressure in this state, both mold halves are opened and a front-end panel with an antistatic thin-layered matter integrally laminated to its surface is taken out of the mold (FIG. 22).

As one embodiment of a thermoplastic resin to be used in the production of front-end panels as described above, a molten thermoplastic resin containing reinforcing fibers whose average fiber length is kept at 1 mm or more may be used. In this case, since the reinforcing fibers are filled in the whole article, a vehicle front-end panel made of thermoplastic resin superior in strength and impact resistance is obtained.

In the case of using such a molten resin containing reinforcing fibers, there may be mentioned, for example, a method in which a molten resin prepared by melt-kneading reinforcing fibers having an average fiber length of 3 mm or more and granular or pelleted thermoplastic resin in, for example, an injection machine with an in-line type screw installed therein is supplied into a mold-cavity and a method in which a molten resin prepared by melt-kneading preformed thermoplastic resin material containing reinforcing fibers having an average fiber length of 3 mm or more, for example, long fiber-reinforced thermoplastic resin pellets is supplied into a mold-cavity.

In the latter method, as the long-fiber-reinforced resin pellets are suitably employed those prepared by impregnating glass roving with a molten thermoplastic resin and cutting to pellet the resulting cooled and solidified product into a proper length, for example, about 3-25 mm.

Such long-fiber reinforced thermoplastic resin pellets may be used alone or may be used after being mixed with resin pellets comprising the matrix resin of the long-fiber-reinforced thermoplastic resin pellets. In some cases, the long-fiber reinforced thermoplastic resin pellets may be blended with another thermoplastic resin pellets.

As the reinforcing fibers, various types of conventionally known reinforcing fibers such as glass fibers, carbon fibers and alumina fibers may be applied here. Glass fiber is used as the most popular one.

As the adhesion of such reinforcing fibers to the thermoplastic resin which is a matrix is enhanced, the linkage between fibers through the matrix resin becomes stronger and the strength of expanded articles is also improved. Accordingly, for a combination, for example, of a polypropylene-based resin and glass fibers, improving their adhesion by surface treatment of the glass fibers or by mixing a modifier to the thermoplastic resin is effective.

Although the content of reinforcing fibers varies depending upon the strength of a desired vehicle front-end panel made of thermoplastic resin, it generally ranges 10 to 80% by weight.

The front-end panels made of thermoplastic resin of the present invention are widely used for vehicles by making the most of their characteristics that they are very light because their substrates are composed of thermoplastic resin and they are superior in electrical conductivity and/or antistatic properties.

What is claimed is:

1. A vehicle front-end panel made of a thermoplastic resin for constituting a vehicle front-end module, wherein the front-end panel comprises:
(a) a thermoplastic resin; and
(b-i) an electrically conductive material and/or (b-ii) an antistatic material.

2. The vehicle front-end panel made of a thermoplastic resin according to claim 1 wherein the front-end panel has an internal resistivity of less than 1×10⁻¹ Ω·cm.

3. The vehicle front-end panel made of a thermoplastic resin for vehicles according to claim 1 wherein the front-end panel has a surface resistivity of less than 1×10¹⁴ Ω·cm.

4. The vehicle front-end panel made of a thermoplastic resin according to claim 1 wherein the front-end panel has a surface resistivity of less than 1×10¹⁰ Ω·cm.

5. The vehicle front-end panel made of a thermoplastic resin according to claim 1 wherein the front-end panel has an internal resistivity of less than 1×10⁻¹ Ω·cm and a surface resistivity of less than 1×10¹⁴ Ω·cm.

6. The vehicle front-end panel made of a thermoplastic resin according to claim 1 wherein the electrically conductive material and/or the antistatic material is contained in the thermoplastic resin.

7. The vehicle front-end panel made of a thermoplastic resin according to claim 1 wherein the electrically conductive material and/or the antistatic material is present on a surface of the thermoplastic resin.

8. The vehicle front-end panel made of a thermoplastic resin according to claim 1 wherein the front-end panel comprises (a) the thermoplastic resin and (b-i) the electrically conductive material.

9. The vehicle front-end panel made of a thermoplastic resin according to claim 8 wherein the electrically conductive material is an electrically conductive porous thin-layered matter which is impregnated with the thermoplastic resin.

10. The vehicle front-end panel made of a thermoplastic resin according to claim 8 wherein the electrically conductive material is an electrically conductive thin-layered matter which is integrally laminated to the thermoplastic resin.

11. The vehicle front-end panel made of a thermoplastic resin according to claim 8 wherein the electrically conductive material is applied to a surface of the thermoplastic resin.

12. The vehicle front-end panel made of a thermoplastic resin according to claim 1 wherein the front-end panel comprises (a) the thermoplastic resin and (b-ii) the antistatic material.

13. The vehicle front-end panel made of a thermoplastic resin according to claim 12 wherein the antistatic material is applied to a surface of the thermoplastic resin.

14. The vehicle front-end panel made of a thermoplastic resin according to claim 12 wherein the antistatic material is an antistatic thin-layered matter which is integrally laminated to the thermoplastic resin.
